(19) United States
(12) Patent Application Publication
(10) Pub. No.: US 2003/0046156 A1
(43) Pub. Date: Mar. 6, 2003

(54) Apparatus and method for configuring web pages to maximize profits using sales, inventory, and cost data

(75) Inventors: Daryl Carvis Cromer, Apex, NC (US); Howard Jeffrey Locker, Cary, NC (US); James Peter Ward, Raleigh, NC (US)

Correspondence Address: International Business Machines Corporation, Personal and Printing Systems Group, Dept. 9CCA/Bldg. 002-2, P.O. Box 12195, Research Triangle Park, NC, 27709, US

(73) Assignee: International Business Machines Corporation, Armonk, NY

(21) Appl. No.: 09/943,344

(22) Filed: Aug. 30, 2001

(51) Int. Cl. G06F 17/60

(52) U.S. Cl. 705/14; 705/1

(57) ABSTRACT

A computer-implemented method determines which products are to be advertised as specials on web pages or in another form of advertisement, based on comparing scores generated for each product within a number of products offered for sale to predict the profit potential of the product. Preferably, the score is generated by multiplying a profit factor, indicating a profit for each sale, by a sales factor, determining the likelihood of selling the product, and by an inventory factor, which is included to prevent the advertisement of a product for which an inadequate inventory is held as a special. Preferably, web pages are automatically generated at a predetermined time with products having the best scores being advertised as specials.

### BACKGROUND OF THE INVENTION

1. Field of the Invention

This invention relates to the generation of web pages to be transmitted on the Internet, and, more particularly, to the generation of such web pages in a manner featuring one or more products chosen by an algorithm to indicate a relatively high potential for profits from the sale of such products.

2. Background Information

A large number of organizations generate web pages to share information over the Internet with potential customers on products being offered for sale. Often, these web pages acquire the form of a large, multi-page catalog listing thousands of items for sale. This use of the Internet has a particular advantage of providing the potential customer both with information describing the available products and with a convenient method for ordering the products he chooses, with individual products being selected with a mouse using an Internet browser.

While this use of web pages tends to be inexpensive, considering the number of customers that can be reached over the Internet and the number of products which can be advertised, a limitation is quickly reached in terms of the amount of time individual customers are willing to spend searching through the web pages. For this reason, attempts are often made to feature certain products being offered for sale as special, featured items. On the web pages, the advertising descriptions for such items are characterized by their placement in locations which will be first noticed as the customer examines the web pages, by the size of the description, including both text and graphical images, and by the amount of information included in the description.

A number of patents describe methods for generating and using advertisements presented on web pages accessed over the Internet by client systems. For example, U.S. Pat. No. 5,960,411, the disclosure of which is incorporated herein by reference, describes a method and system for placing an order to purchase an item via the Internet. The order is placed by a purchaser at a client system and received by a server system. The server system receives purchaser information including identification of the purchaser, payment information, and shipment information from the client system. The server system then assigns a client identifier to the client system and associates the assigned client identifier with the received purchaser information. Also, U.S. Pat. No. 5,724,424, the disclosure of which is incorporated herein by reference, describes a complete system for the purchasing of goods or information over a computer network. Merchant computers on the network maintain databases of digital advertisements that are accessed by buyer computers. In response to user inquiries, buyer computers retrieve and display digital advertisements from merchant computers. What is needed is a method to automate changes in the presentation of advertised material in response to rapidly changing sales conditions.

A number of patents describe methods to select advertising information to be provided to a particular customer in a particular transaction situation, based on the actions of the customer. For example, U.S. Pat. No. 6,144,944 describes a system for selecting and providing information from an advertisement server in response to a request from a web page server, with this request including information allowing the advertisement server to select an appropriate advertisement. This information includes, for example, demographic information and information describing how the customer found a particular item, such as the web page or keyword used. The advertisement server includes a control program for controlling the selection of the advertisements.

Another method for selecting advertising information, based on the actions of the particular customer, is described in U.S. Pat. No. 6,092,049. Profiles of items are stored, associating particular customers with ratings given by the customers to the items or inferred from the actions of the customers, such as the length of time a particular user views a particular web page or whether the customer mails information from a web page to others.

Yet another method for selecting advertising information, based on the actions of a particular customer, is found in U.S. Pat. No. 6,055,573, in which an advertiser's server delivers an advertisement to a customer's computer after receiving an identifier transmitted by the customer's computer after the placement of a cookie in the customer's computer. The targeted advertisement is based on the observed offline purchase history of a consumer associated with the first identifier. The invention includes the delivery of a promotional incentive for a customer to comply with a particular behavior pattern. The customer is provided with a customer identification that is entered to store data in a data structure when the customer makes a purchase at a participating retail store.

A disadvantage of generating a sequence of advertisements for a particular customer following his request to see information on a particular item arises from the fact that this process must occur in real time following the customer's input. If the customer is to be retained and served, he must not be required to wait an inordinate period while a sequence of advertisements is prepared for transmission. On the other hand, advertisements sent to the customer from an advertiser's server not operating in response to his particular request for information are often rejected as unwelcome “spam” from the Internet. Furthermore, at least some of the methods used to gain information on a particular customer for selection of a sequence of advertisements are being viewed with increasing scrutiny as invasions of privacy. Therefore, what is needed is a method for preparing a sequence of advertisements to be used by all customers at a particular web site, with regard for the financial objectives of the organization operating the web site, but without regard for the characteristics of individual customers.

Other patents describe methods for determining which promotions should be used within a retail environment based on recent customer purchases. Such methods may help an organization react to changes in buying habits occurring too rapidly to be noticed by ordinary methods of observation. For example, U.S. Pat. No. 5,774,868 describes an automated sales promotion selection system using neural networks to identify promising sales promotions based on recent customer purchases. The system includes a customer information device that receives customer data relating to customer purchases of items from an inventory of items, a central processing unit having a sales promotion neural network and a storage unit containing a plurality of item identifiers.

U.S. Pat. No. 6,029,139 describes another method for determining which promotions should be used. The method, which takes into account products related to, or competing with, the products being promoted, includes generating a data structure corresponding to the sales history for a product, having an event type domain, a time domain, and a unit of measurement domain. A promotion optimization system determines both the costs and benefits of a proposed promotion plan for the sale of products. Using both the costs and benefits, it proposes a promotional plan that will better meet the user's goals.

While the methods of U.S. Pat. Nos. 5,774,868 and 6,029,139 perform various calculations to determine optimum promotion plans, what is needed is a method for implementing a selected promotion plan by generating a series of advertising messages that can be made part of an electronic catalog presented on a series of web pages available for selection over the Internet.

### SUMMARY OF THE INVENTION

In accordance with a first aspect of the present invention, a computer-implemented method is provided for generating advertising information offering a plurality of products for sale. The advertising information includes a plurality of locations for individual advertisements, having at least one special location for prominently advertising a special product. The method includes providing a first data structure including an entry for each product within the plurality of products, wherein the first data structure includes a field identifying each the product and a field including data relating to profit from sales of each the product, generating a score for each product within the plurality of products from the data relating to profit from sales, comparing the score for each product within the plurality of products to determine at least one product with promising profit from sales, and writing at least one code identifying at least one product with promising profit from sales to a selection data structure.

Preferably, the method also includes reading the at least one code from the selection data structure, reading product advertising information corresponding to the at least one product from a second data structure including an entry for each product within the plurality of products, an identification field including a code identifying each the product and an information field including information describing each the product; and writing the product advertising information corresponding to the at least one product to a computer readable medium in at least one location corresponding to at least one special location for prominently advertising a special product. Preferably, the computer readable medium includes a computer data structure storing data for presentation as one or more web pages, with this data for presentation causing a standard browser to display data in a predetermined manner.

Preferably, the field including data relating to profit from sales of each the product includes a field storing data describing profits from an individual sale of each the product and a field storing sales data describing a level of sales of each the product, the step of providing the first data structure includes updating the sales data, and the step of generating a score for each product includes multiplying the data relating to profit from sales of each the product by the sales data for each the product to obtain expected profit data. Preferably, the first data structure additionally includes a field storing an inventory function derived from inventory data for each the product, the step of providing the first data structure includes updating the inventory function, and the step of generating a score for each product includes multiplying the expected profit data by the inventory function to lower the score for a product having a low level of inventory.

### BRIEF DESCRIPTION OF THE DRAWINGS

FIG. 1 is a block diagram of a system configured to operate according to the invention;

FIG. 2 is a block diagram of a web server in the system of FIG. 1;

FIG. 3 is a block diagram of an inventory control computer in the system of FIG. 1;

FIG. 4 is a pictographic view of the tree structure of a first version of web pages generated by the system of FIG. 1 in accordance with the invention;

FIG. 5 is a pictographic view of the tree structure of a second version of the web pages generated by the system of FIG. 1 in accordance with the invention;

FIG. 6 is a diagram showing the fields within an entry of the inventory control data structure stored within the inventory control computer of FIG. 3;

FIG. 7 is a flow chart of a first version of a process occurring within the system of

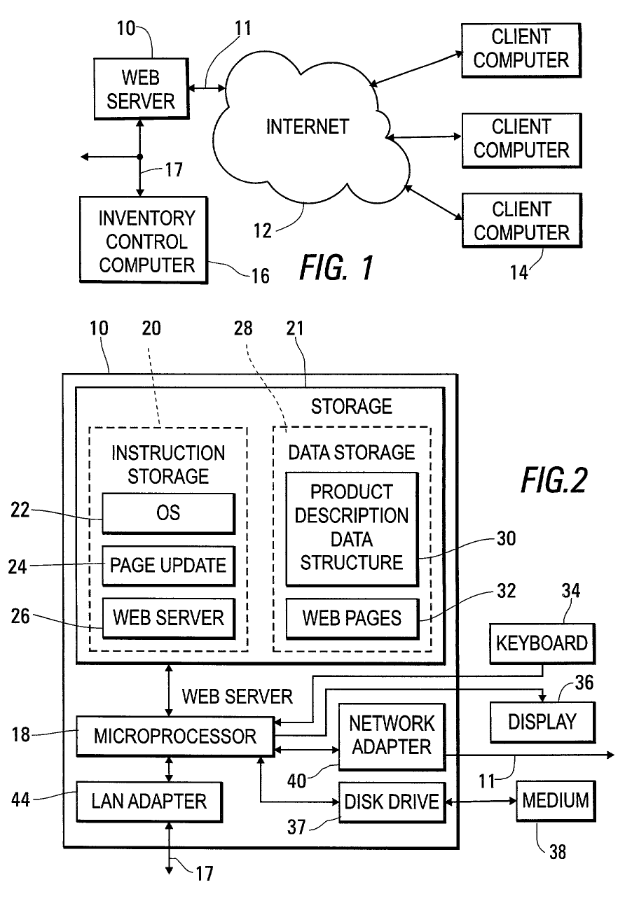

FIG. 1 to generate web pages in accordance with the invention;

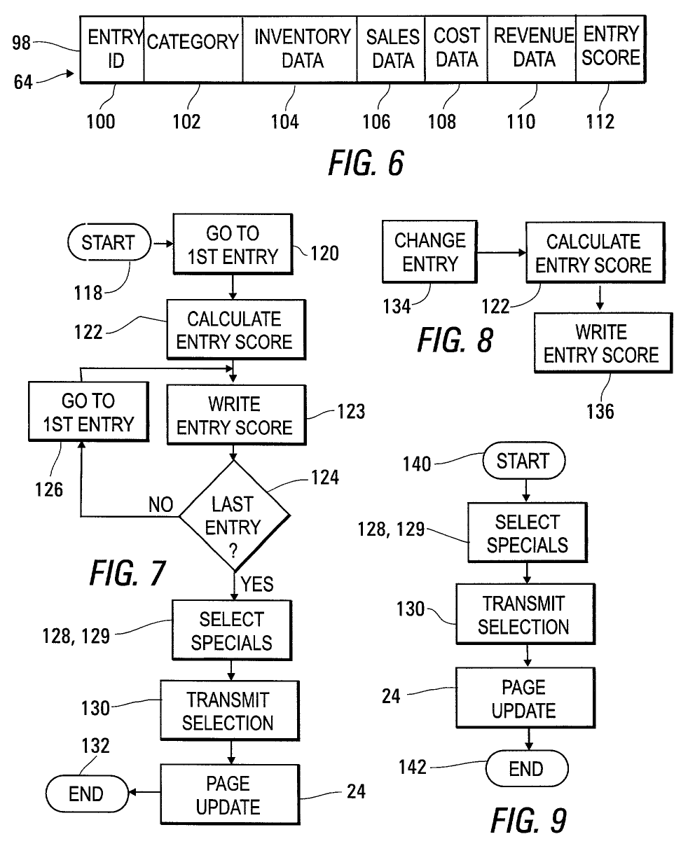

FIG. 8 is a flow chart of a process for updating entry scores in the inventory control data structure of FIG. 6 as changes are made to other fields within the entry;

FIG. 9 is a flow chart of a portion of a second version of a process occurring within the system of FIG. 1 to generate web pages in accordance with the invention, following the process of FIG. 8;

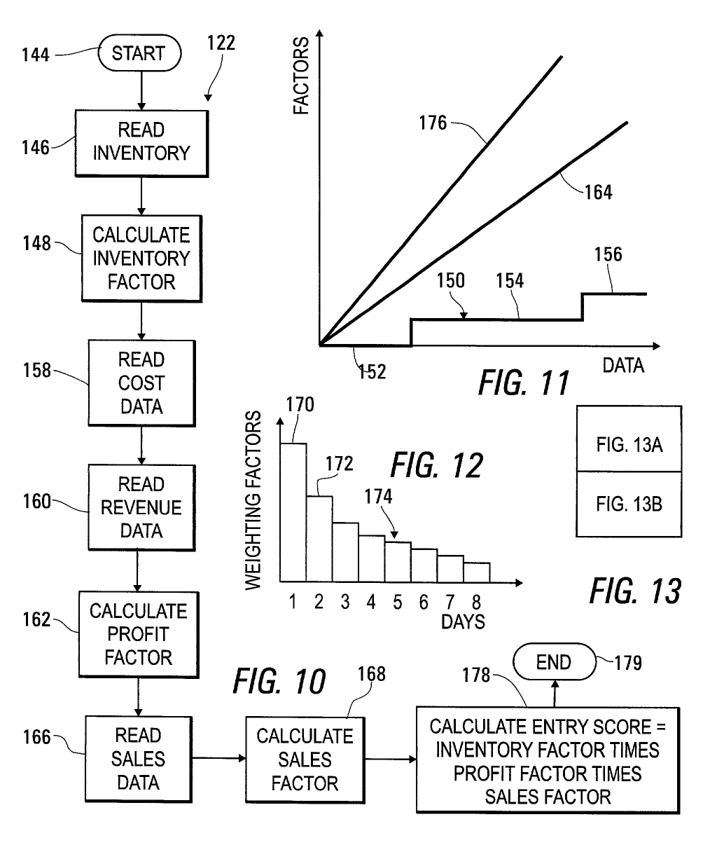

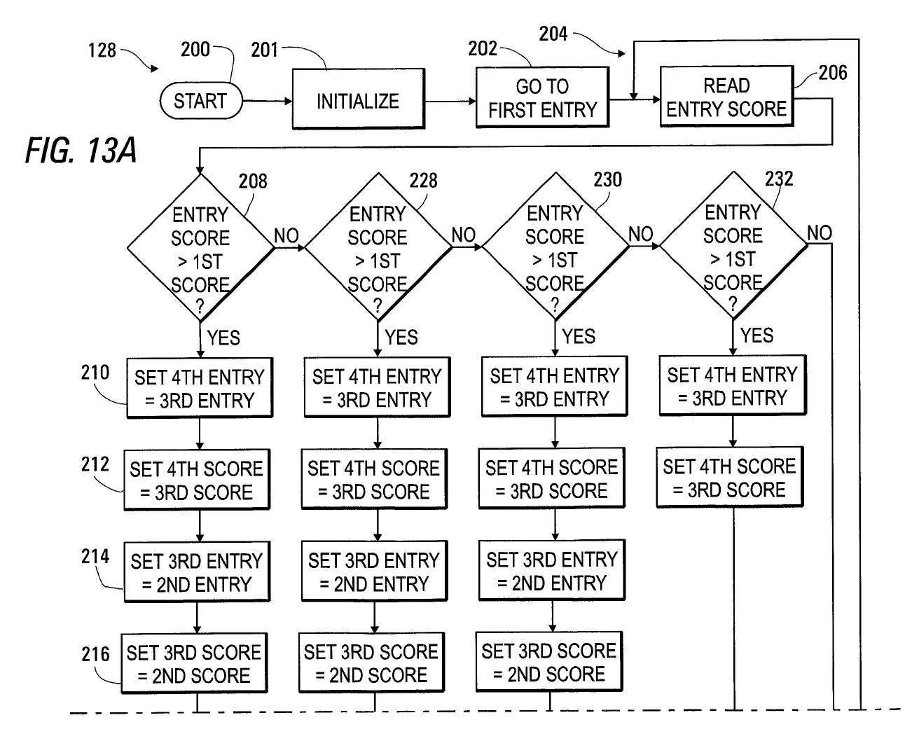

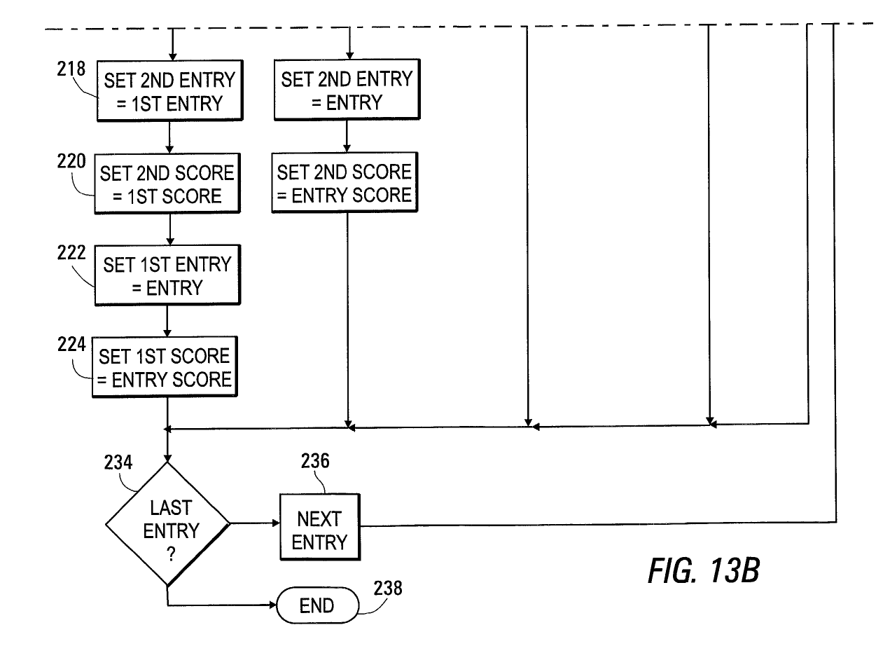

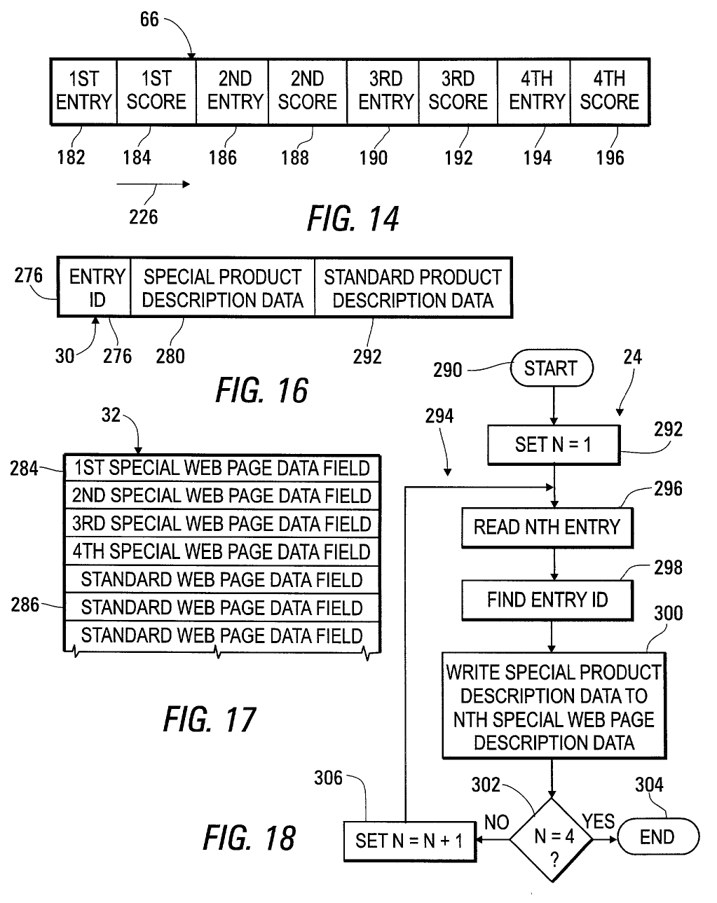

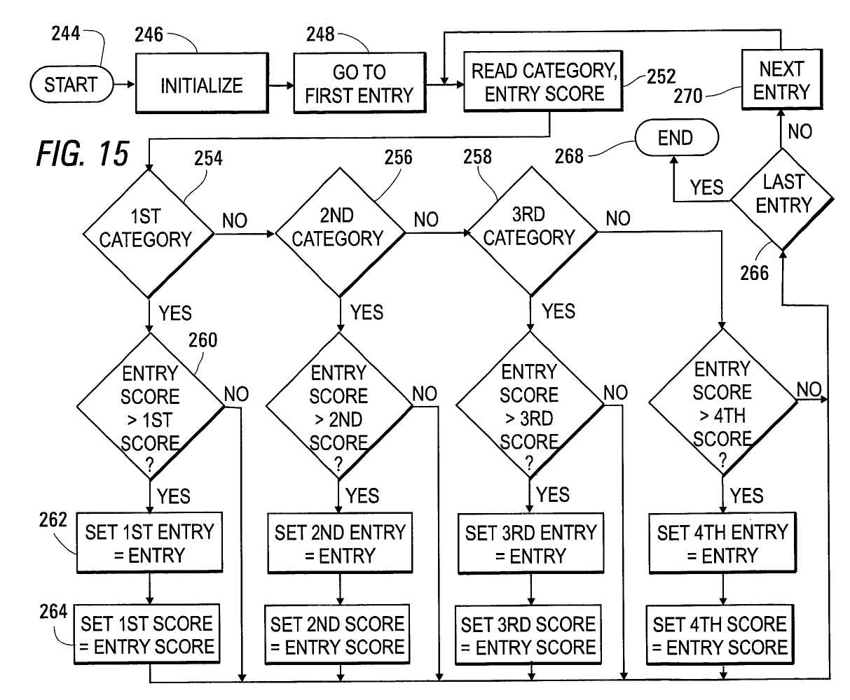

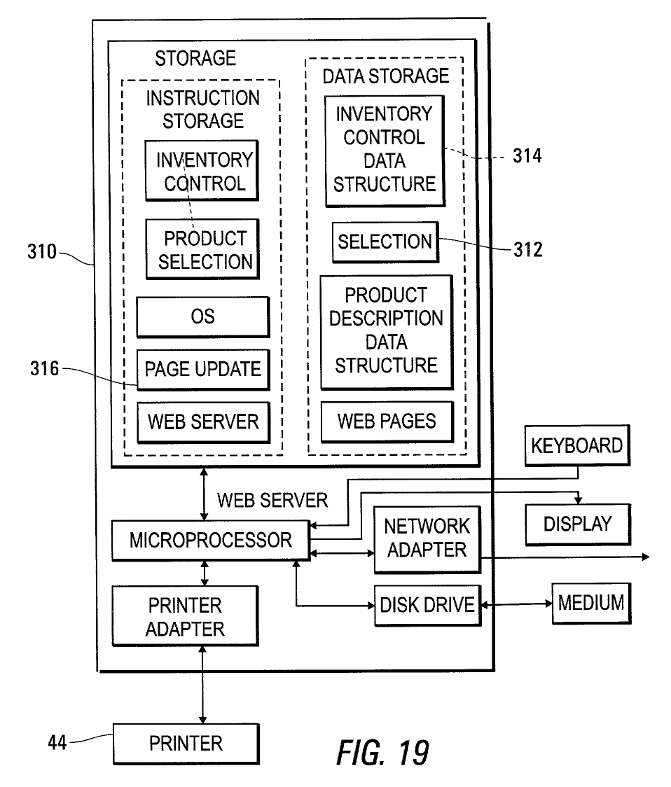

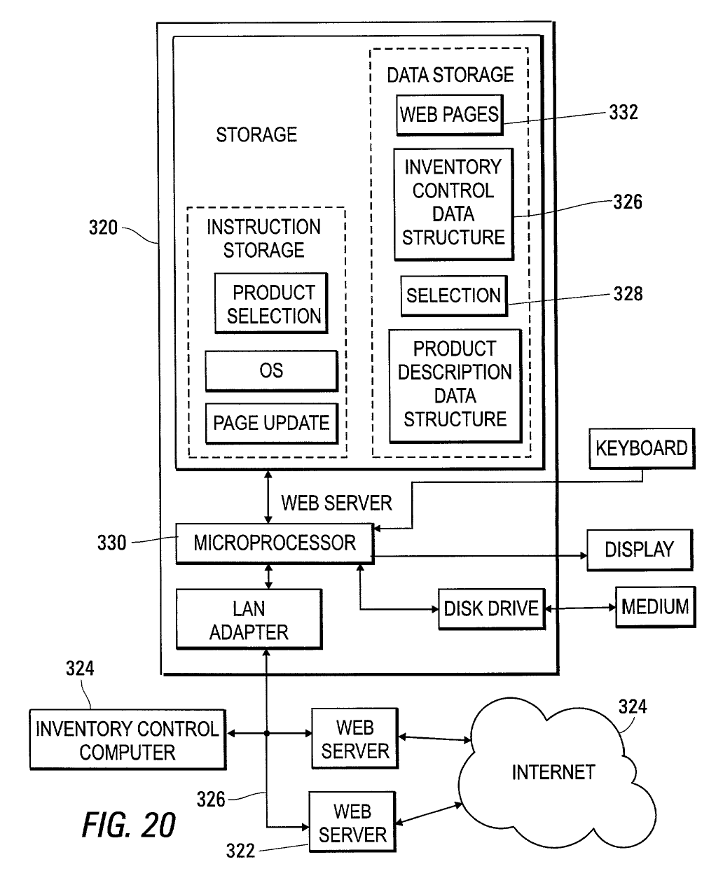

FIG. 10 is a flow chart of a subroutine used in the process of FIG. 7 and in the alternate process of FIG. 8 to calculate the entry score of an individual entry in the inventory control data structure of FIG. 6,

FIG. 11 is a graphical view of factors calculated during the execution of the subroutine of FIG. 10;

FIG. 12 is a graphical view of weighting factors applied to calculate a sales factor in the subroutine of FIG. 10;

FIG. 13 is a flow chart of a subroutine to select specials within the processes of FIGS. 7 and 9, to form web pages arranged in the manner of FIG. 4, with FIG. 13A being an upper portion thereof, and with FIG. 13B being a lower portion thereof;

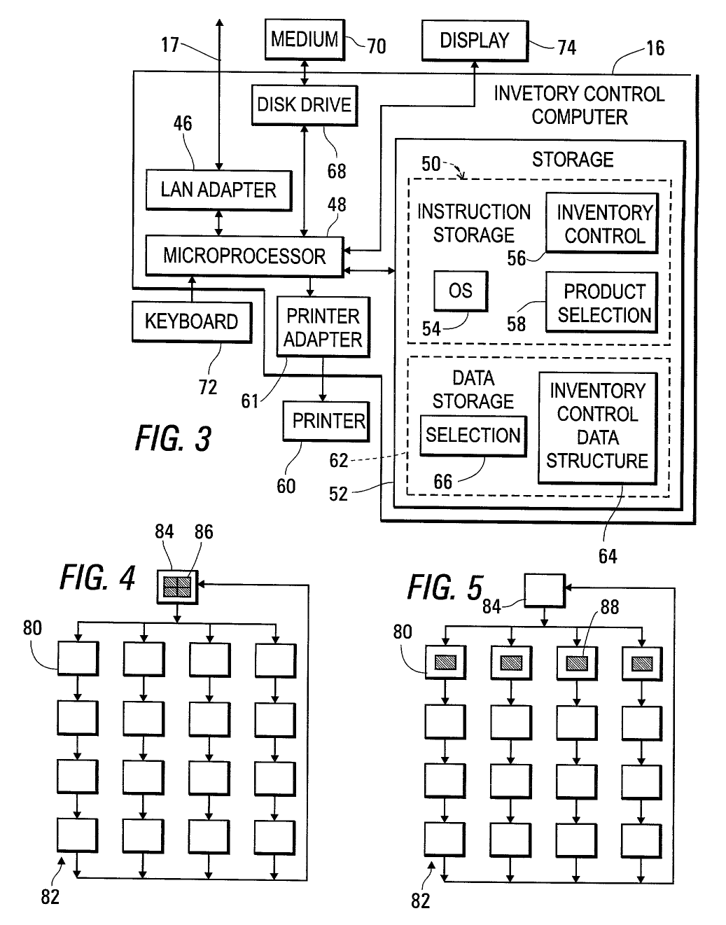

FIG. 14 is a diagram of the selection data structure within the inventory control computer of FIG. 3;

FIG. 15 is a flow chart of a subroutine to select specials within the processes of FIGS. 7 and 9 to form web pages arranged in the manner of FIG. 5;

FIG. 16 is a diagram showing data fields within an entry of a product description data structure stored in the web server of FIG. 2;

FIG. 17 is a diagram showing data fields within a web pages data structure stored in the web server of FIG. 2;

FIG. 18 is a is a flow chart of a page update routine executing in the web server of FIG. 2;

FIG. 19 is a block diagram of a first alternative system configured to operate according to the invention; and

FIG. 20 is a block diagram of a second alternative system configured to operate according to the invention.

### DETAILED DESCRIPTION OF THE INVENTION

FIG. 1 is a block diagram of a system configured to operate according to a first embodiment of the invention. The system includes a web server 10, connected through a telephone line 11 to a wide area network, such as the Internet 12, to communicate with a number of client computers 14, and an inventory control computer 16, which stores various kinds of information relating to the selling of products, and which performs various calculations using this data both in support of sales operations and in support of the generation of optimized web pages in accordance with the present invention.

FIG. 2 is a block diagram of the web server 10 of the system of FIG. 1. The web server 10 includes a microprocessor 18 executing a number of programs or routines stored in instruction storage 20 within storage 21. These routines 20 include an operating system 22, such as UNIX, a web page update program 24, which is executed to design web pages in accordance with the present invention, and a web server program 26. The web server program 26 is used to present the web pages designed with the web page update program 24 to client computers 14 over the Internet 12, to support the process of moving through the web pages with the browser of a client computer 14, and to receive, store, and to transmit data regarding the selections of products made using the browser of a client computer 14 and methods chosen for payment for selected products. The web server program 26 may be of a conventional type, performing these operations as described, for example, in U.S. Pat. Nos. 5,960,411 or 5,724,424, the disclosure of which is incorporated herein by reference.

Storage 21 also contains data storage 28, including a product description data structure 28, which stores information regarding each of the products being advertised within the web pages being distributed through the web server program 26. This data includes text information and graphical information used in the descriptions of individual products, and pricing information for each of the products. The data storage 28 also includes a web pages data structure 32, which stores the data generated within the web page update program 24 in a form used to present web pages over the Internet 12, along with other data structures and files required to store data associated with the execution of routines in instruction storage 22.

Storage 21 is preferably implemented using conventional components to include both volatile and non-volatile components. Non-volatile storage is formed using, for example, one or more hard disk drives, which may store information in a redundant method now conventionally used in servers. Volatile storage is formed using, for example, dynamic random access memory modules (DRAM). Programs or routines are typically stored in non-volatile memory, to be available after the web server 1 0 is turned off and on, and to be loaded as needed into the volatile storage for execution within the microprocessor 18. The operating system 22 then runs ether concurrently with the web page update program 24 or with the web server program 26. Preferably, the web page update program 24 is used on a periodic basis to update the web pages in response to changes in measured sales and revenue associated with the individual products being offered for sale.

The web server 10 also includes a number of additional conventional components, receiving operator inputs trough a keyboard 34, and providing output data through a display 36. Both data and program instructions are loaded through a disk drive 37, which reads data from a removable, computer readable medium 38, such as a floppy diskette or a compact disk. A connection with the Internet 12, or other wide area network, is made through a network adapter 40, which, depending on the type of telephone line 11, may be a conventional modem, or which may be an adapter capable of connection to a large number of communication channels, using, for example, ISDN (Integrated Services Digital Network). The web server 10 is also connected to the inventory control computer 16 through the LAN 17 extending from a LAN adapter 44 in the web server and a LAN adapter 46 in the inventory control computer 16.

FIG. 3 is a block diagram of the inventory control computer 16 in the system of FIG. 1, which is connected to the web server 10 through the LAN 17 extending from a LAN adapter 46 within the inventory control computer 16. The inventory control computer 16 includes a microprocessor 48, which executes programs and routines stored in instruction storage 50 within storage 52. These routines include an operating system 52, an inventory control program 54, and a product selection program 58. The inventory control program 64 provides various functions related to the operation of the organization, with the nature and scope of the functions depending on the needs of the organization. For example, the inventory control program 64 may track levels of inventory for each item, print labels for shipping products, and prepare various other types of documentation associated with receiving and shipping products. Such documentation is printed on a printer 60, driven through a printer adapter 61. Storage 52 also includes data storage 62, which stores inventory control data structure 64 storing information relating to each product being offered for sale.

The product selection program 58, executing within the microprocessor 48, uses data from the inventory control data structure 64 to determine which products are to be selected for display as specials in the web pages being presented through the web server 10. Data describing these selected products is stored in a selection file 66 within data storage 62.

Like storage 21, storage 52 is preferably implemented using conventional components to include both volatile and non-volatile components. Non-volatile storage is formed using, for example, one or more hard disk drives, which may store information in a redundant method now conventionally used in servers. Volatile storage is formed using, for example, dynamic random access memory modules (DRAM). Programs or routines are typically stored in non-volatile memory, to be available after the inventory control computer 16 is turned off and on, and to be loaded as needed into the volatile storage for execution within the microprocessor 48. The operating system 54 then runs either concurrently with the inventory control program 56 or with the product selection program 58. Preferably, the product selection program 58 is used on a periodic basis to determine how the web pages are to be updated in response to changes in measured sales and revenue associated with the individual products being offered for sale.

Both programs and data are provided as inputs through a disk drive 68, which reads data from a removable computer readable medium 70. Operator inputs are also provided through a keyboard 72, with various types of results being presented on a display device 74.

FIGS. 4 and 5 are pictographic views of a tree structure of web pages generated by the system of FIG. 1 in accordance with the present invention. In general, a web site of the type to which the present invention would be applied, includes a number of individual web pages 80, which are arranged in columns 82 according to the categories of items being offered for sale. The arrows indicate links between the web pages 80, beginning with a home page 84 from which each category forming a column 82 is selected. Within an individual column 82, the arrows indicate directions of movement among the web pages 80 as the “next page” browser button is selected on a client computer 14 (shown in FIG. 1), with movement opposite the direction of the arrows occurring when the “back” or “previous page” button on the browser is selected. Additional links may be provided among the web pates 80. In the example of FIG. 4, four items are 86 selected for advertisement as specials on the home page 84. The four items having the highest four entry scores, determined according to the invention, are displayed in this way, regardless of the categories in which they reside. In the example of FIG. 5, an item 88 having the highest entry score among each category is selected for advertisement as a special on the first web page 90 of each category. In general, an item being advertised as a special may be characterized by its placement among the web pages, by the size of the advertisement, and by the quantity of data within the web pages.

FIG. 6 is a diagram showing the fields of the inventory control data structure 64 of the inventory control computer 16, shown in FIG. 3. Each different item being offered for sale in the web pages generated within the web server 10 is represented by a single entry 98 in the product control data structure 64, with the entry 98 comprising the fields of FIG. 6. While only one entry 98 is shown, it is understood that the inventory control data structure 64 includes a number of entries, with one entry being provided for each different item or product being offered for sale in the web pages being generated.

The first field 100 of the data structure 64 includes an entry ID for each entry 98 in the data structure 64. The second field 102 identifies the category in which the entry 98 resides, determining, for example, the columns 82 of the diagrams of FIGS. 5 and 6 in which information corresponding to the entry 98 belongs. The third field 104 contains inventory data, such as the quantity of items presently available for sale. This inventory data may be simply reflect the number of items to be found within a warehouse, or it may be constructed to reflect a method of doing business, including, for example, items available for shipment from reliable suppliers.

The fourth field 106 contains sales data, which is used both as an indicator of a potential for future sales and as a measure for judging the adequacy of the current levels of inventory to meet sales demands. The length of time during which sales data is retained and analyzed depends on the volatility of the sales of the particular item represented by the entry 98 in the inventory control data structure 63. If sales are particularly volatile, as indicated by high rates of change of sales volumes in either direction, data from the last day or two may be weighted as having particular importance.

The fifth field 108 and the sixth field 110 contain data which is used to calculate the expected profit from selling one of the items described within the entry 98 in the inventory control data structure 64. Preferably, the extent of the cost data stored in the sixth field 110 depends on the nature of the business incurring the costs. In the simplest example, the cost data may merely reflect the wholesale cost of a product being sold for a retail price. The cost data may additionally reflect other costs, such as storage costs associated with inventory; overhead costs, shipping costs, the costs of advertising and promotion. A detailed description of costs to be evaluated is found in U.S. Pat. No. 6,029,139, the disclosure of which is included herein by reference. The sixth field 110 contains revenue data, which generally indicates the revenue to be received when an item is sold. If quantity discounts are being made available, their effect may be figured into an average revenue. The seventh field 112 contains an entry score for the particular entry 98, which is calculated in a manner in reference to FIGS. 7 and 8. In accordance with the present invention, the entry score is used to determine which items should be featured as specials in the web pages being developed for delivery through the web server 10.

FIG. 7 is a flow chart of a process 117 occurring within the system of FIG. 1 to generate web pages in accordance with the present invention. Preferably, this program is started, in step 118, on a periodic basis to update the web pages delivered through the web server 10 with the most recent data. For example, the processes of FIG. 7 may begin at a predetermined time each night, when demands on the web server 10 and the inventory control computer 16 are at relatively low levels. The frequency at which the process of FIG. 7 occurs is preferably determined according to the volatility of the business being conducted using the web pages. In particular, the present invention provides a way to take advantage of the rapid fluctuations of sales volumes in a fad market, provided the processes of FIG. 7 are initiated often enough that such fluctuations can be detected.

After this process is started in step 118, the system goes to the first entry 98 in the inventory control data structure 64 in step 120. Next, in a subroutine 122, the entry score for this entry 98 is calculated, as described below in reference to FIG. 10. Then, in step 124, a determination is made of whether the entry 98 presently being examined is the last entry 98 of the data structure 64. If it is not, the system moves to the next entity of the inventory control data structure 64 in step 126, with the system returning to step 122 to calculate an entry score for this new entry 98. Then, in step 123, the calculated entry score is written in the data field 112 for the entry 98.

When the last entry 98 in the data structure has been processed, the system proceeds to a subroutine 128, in which the entry score field 112 of the inventory control data structure 64 is evaluated in a manner to be discussed in reference to FIG. 13, in order to determine selections to be advertised as specials in web pages configured as described above in reference to FIG. 4. Alternately, the system proceeds to a subroutine 129, in which the category field 102 and the entry score field 112 of the inventory control data structure 64 are evaluated to determine the entry 98 having the highest entry score in each category, in order to determine selections to be advertised as specials in web pages configured as described above in reference to FIG. 5. After the specials are selected by subroutine 128 or 129, the entry IDS, read from data field 100 of the entries 98 in the inventory control data structure 64 selected as specials, are transmitted to the web server 10. This transmission may be in response to the completion of the subroutine 128 or 129, in response to a call from the web server 10, or in response to the arrival of a predetermined time for transmission. Then the system proceeds to a subroutine 24, in which the web pages made available through the web server 10 are updated to describe the items corresponding to the selected entries 98 as specials. Finally, this process ends in step 132.

When the process of FIG. 7 occurs within the system of FIG. 1, steps and subroutines 120 through 128 or 129 occur within the inventory control computer 16. After the subroutine 128 or 129 is completed, entry ID codes, from the field 100 of the inventory control data structure 64, corresponding to those entries 98 corresponding to selected specials, are transmitted from the inventory control computer 16 to the web server 10. Then, subroutine 24 is executed within the web server 10. Thus, in the process of FIG. 7, subroutine 122 is applied to calculate an entry score, to be placed in field 112 for each entry 96, before the subroutine 128 or 129 is executed to select the specials. In other words, the product selection routines 58 in instruction storage 50 of the inventory control computer 16 include steps and subroutines 120 through 128 or 129, while the page update routines 24 in instruction storage 20 of the web server 10 include the subroutine 24.

FIGS. 8 and 9 are flow charts representing an alternative process, in which the entry score in the field 112 for each entry 98 is updated whenever data affecting the entry score is changed. Thus, in the alternative process, when the one or more of the fields within one of the entries 98 of the inventory control computer 16 is changed in step 154 of FIG. 8, in a way effecting the entry score in the field 112 of this entry, the entry score is recalculated, and the results are recorded in the entry score field 112 in step 136. For example, selling one or more items effects both the sales data of field 106 and the inventory data of step 104. In this way, the entry score field 112 is kept up to date as other fields are changed in the inventory data structure 64, so the subroutine 128 or the alternate subroutine 129 to select specials is run after the alternate process of FIG. 9 is started in step 140. Then, the subroutine 24 is run to update the web pages, and the process is ended in step 142. When the processes of FIGS. 8 and 9 occur in the system of FIG. 1, the processes of FIG. 8 and the subroutine 128 or 129 of FIG. 9 are executed in the inventory control computer 16, and the subroutine 24 is executed in the web server 10.

FIG. 10 is a flow chart of the subroutine 122 of FIGS. 7 and 8, which is used to calculate the entry score of an individual entry 98 within the inventory control data structure 64. In the process of FIG. 7, this subroutine 122 is applied repeatedly, until an entry score has been calculated for each entry in the inventory control data structure 64. In the alternative process of FIG. 8, this subroutine 122 is applied after each change affecting the entry score is made. During the subroutine 122, three factors are calculated and multiplied together to determine an entry score for the particular entry 98.

FIG. 11 is a graphical view of the factors calculated during the execution of the subroutine 122 as functions of the levels of data read from the various fields of the inventory control data structure 64 in the entry 98 being evaluated.

After the subroutine 122 is started in step 144, the inventory data for the entry 98 is read from field 100 in step 146. Then, in step 148, an inventory factor is calculated. Preferably, the inventory data calculations reflect not only the number of units available in storage, but also the time in which such units should be available, taking into account sales data as well as the number of units in storage. In general, a process is in place to order replacement stock when inventory levels become inadequate. Such a process is, for example, carried out manually through order placement after reviewing inventory data from field 100 or more automatically, with orders being prepared in response to low levels. The most significant purpose of using the inventory factor in the calculations of subroutine 122 is to prevent an item from being advertised as a special if it cannot be readily supplied because of an insufficient inventory level. To achieve these ends, the inventory factor may be generated according to a first curve 150 of FIG. 11, with a first section 152, corresponding to levels of inventory so low that it cannot be replaced fast enough to support continued sales in the event that sales are increased through the advertisement of the corresponding item as a special. A second level portion 154 of the curve 150 is flat, indicating that the inventory can be replaced fast enough to compensate for increased sales. Finally, at the higher level 156 of the curve 150, the value of the inventory factor is increased to reflect the desirability of selling products having inventory levels that are too high.

After completing the calculation of the inventory factor in step 148, the system proceeds to step 158 to read the cost data from field 108, and then to step 160 to read the revenue data from field 110. Then, in step 162, a profit factor is determined by subtracting cost data from revenue data. In general, the profit factor, as represented by line 164, is directly proportional to a data function formed by subtracting the cost data from the revenue data.

Next, in step 166, the sales data is read from field 106, with a sales factor being calculated in step 168. Preferably, the sales factor is used both as a multiplier to provide an indication of the total profits from the profit factor, which reflects profit per unit, and additionally as a means for making the algorithm responsive to rapid changes in sales.

FIG. 12 is a graphical view of weighting factors applied to daily sales occurring in previous days. In the first previous day the highest weighting factor 170 is applied. In the second previous day (i.e., the day before the first previous day), a somewhat lower weighting factor 172 is applied, etc. Sales occurring during more remote periods are weighted with successively lower factors. The actual sales for each period are multiplied by the weighting factor of the period, and the results are then added to obtain a single level of sales data. This level is preferably used to generate a sales factor in a linear manner, as shown by line 176 in FIG. 11. In this way, the most recent sales data is given a higher rating than other sales data. The actual weighting factors may be adjusted according to experience with the product being offered for sale or with similar products. For example if significant fluctuations in sales occur more slowly, the time periods of FIG. 12 may be months instead of weeks.

Finally, the entry score for the particular entry 98 is calculated in step 178 by multiplying the inventory factor times the profit factor and times the sales factor, and the subroutine 122 is ended in step 179.

The preceding discussion has provided examples of methods for converting stored data into the three factors that are multiplied together to arrive at an entity score for an entity. In general, the methods used for determining these factors may be varied to meet the business conditions of the organization using the web pages being generated.

FIG. 13 is a flow chart of a subroutine 128, which is executed to select specials to be arranged on web pages in the manner of FIG. 4. This subroutine 128 is executed during the processes of FIGS. 7 and 9. FIG. 13A is an upper portion of FIG. 13, and FIG. 13B is a lower portion thereof. During execution of the subroutine 128, the entry score from field 112 of the inventory control data structure 124 for each entry 98 is studied, and the four highest entry scores, together with the entry IDS of the entries with which these four highest entry scores are associated, are stored in the selection data structure 66 of the inventory control computer 16 (shown in FIG. 3).

FIG. 14 is a diagram of the selection data structure 66 of the inventory control computer 16 of FIG. 3. Following completion of the subroutine 128 the first entry field 182 of this data structure 66 stores the Entry ID from field 100 of the entry 98 having the highest entry score, from field 112 of the inventory control computer 16. Also, this highest entry score is stored in the first score field 184 of this data structure 86. Similarly, the second entry field 186 stores the Entry ID of the entry 98 having the second highest entry score, while the second score field 188 stores this second highest entry score. The third entry field 190 stores the Entry ID of the entry 98 having the third highest entry score, while the third score field 19 stores this third highest entry score. The fourth entry field 194 stores the Entry ID of the entry 98 having the fourth highest entry score, while the fourth score field 196 stores this fourth highest entry score.

Referring to FIGS. 13 and 14, after the subroutine 128 is started in step 200, values within the selection data structure 66 are initialized, with the first score field 184, the second score field 188, the third score field 192, and the fourth score field 196 being set to zero in step 201. Then, the system goes to the first entry 98 within the inventory control data structure 64 in step 202. Next, a loop 204 within the subroutine 128 is repeated until the entry score for each entry 98 has been processed. Within this loop 204, the entry score is first read in step 206. If the entry score is the highest such score yet encountered, i.e. if the entry score just read is greater than the first score stored in the first score field 184, as determined in step 208, the data stored in the fourth entry field 194 is overwritten by the data stored in the third entry field 190 in step 210. Then, in step 212, the data stored in the fourth score field 196 is overwritten with the data stored in the third score field 192. Next, in step 214, the data stored in the third entry field 190 is overwritten with the data stored in the second entry field 186. Then, in step 216, the data stored in the third score field 192 is overwritten with data stored in the second score field 188. Next, in step 218, the data stored in the second entry field 186 is overwritten with data stored in the first entry field 182. Then, in step 220, the data stored in the second score field 188 is overwritten with data stored in the first score field 184. Next, in step 222, the data stored in the first entry field 182 is replaced by the entry ID of the entry 98, stored in data field 100 of the inventory control data structure 64. Then, in step 224, the data stored in the first score field is replaced by the entry score of the entry 98, stored in the entry score field 112 of the data structure 64. Thus, the data stored in the first through third entry fields and score fields is shifted in the direction of arrow 226, and the data from the entry 98 being evaluated is written to the first entry field 182 and to the first score field 184.

On the other hand, if the entry score of the entry 98 being evaluated is not greater than the data stored in the first score field 184, as determined in step 208, but greater than the data stored in the second score field 188, as determined in step 228, the data stored in the second through fourth data fields is shifted in the direction of arrow 226, and the data from the entry 98 is written to the second entry field 186 and the second score field 188.

If the entry score of the entry 98 being evaluated is not greater than the data stored in the second score field 188, as determined in step 228, but greater than the data stored in the third score field 192, as determined in step 230, the data stored in the third entry and score data fields is shifted to the fourth entry and score data fields, and the data from the entry 98 is written to the third entry field 190 and the third score field 192.

If the entry score of the entry 98 being evaluated is not greater than the data stored in the third score field 192, as determined in step 230, but greater than the data stored in the fourth score field 196, as determined in step 232, the data from the entry 98 is written to the fourth entry field 194 and the fourth score field 196.

If the entry score of the entry 98 being evaluated is not greater than the data stored in the fourth score field 196, as determined in step 232, none of the data stored within the selection data structure 66 is changed.

In any case, after the processing described above, the loop 204 continues, with a determination being made in step 234 of whether the entry 98 being examined is the last entry in the inventory control data structure 98. If it is not the last entry, the next entry is chosen for examination in step 236, and the system returns to step 206 to repeat the loop. If the entry 98 that has just been examined is the last entry, the subroutine 128 ends in step 238, with the four highest entry scores and with the entry IDS of the entries associated with these four highest entry scores being stored in the selection data structure 66.

The method described above selects the entries 98 having the four highest entry scores, regardless of their categories. This method defines the items to be advertised as specials in the web page configuration of FIG. 4

FIG. 15 is a flow chart of a subroutine 129, which is executed to select specials to be arranged on web pages in the manner of FIG. 5. This method, which selects the entry 98 having the highest entry score within each category to define the items to be advertised as specials in the web page configuration of FIG. 5, will now be discussed with particular reference being made to FIG. 15, and with continued reference to FIG. 14.

During execution of this subroutine 129, the entry ID and entry score of the entry 98 within the first category having the highest entry score are loaded into the first entry field 182 and the first score field 185, respectively, of the selection data structure 66. Similarly, the entry ID and entry score of the entry 98 within the second category having the highest entry score are loaded into the second entry field 186 and the second score field 188, the entry ID and entry score of the entry 98 within the third category having the highest entry score are loaded into the third entry field 190 and the third score field 192, and the entry ID and the entry score of the entry 98 within the fourth category having the highest entry score are loaded into the fourth entry field 194 and the fourth score field 196.

After the subroutine 129 begins in step 244, values within the selection data structure 66 are initialized, with the first score field 184, the second score field 188, the third score field 192, and the fourth score field 196 being set to zero in step 246. Then, the system goes to the first entry 98 within the inventory control data structure 64 in step 248. Next, a loop 250 within the subroutine 129 is repeated until the entry score for each entry 98 within the product control data structure 64 has been processed. Within this loop 250, for each entry 98, the category from field 102 and the entry score from field 112 are first read in step 252. Next, in steps 254, 256, and 258, the category of the entry 98 is determined. Based on this determination, a subsequent determination is made in a step 260 of whether the entry score of the entry 98 being examined is greater than the entry score stored in the associated (by category) score field, which is the largest entry score yet found for an entry score in the category of the entry 98. If it is, the entry ID of the entry, from field 100 of the entry 98 overwrites the entry ID in the associated field 182, 186, 190, or 194 of the selection data structure 66 in a step 262, and the entry score, from field 112 of the entry 98 overwrites the entry score in the associated field 184, 188, 192, or 196 of the selection data structure in a step 264. If the entry score of the entry 98 being examined is not greater than the entry score stored in the associated score field, the data in the associated field 182, 186, 190, or 194 and 184, 188, 192, or 196 is not overwritten. In either case, the system proceeds to step 266, in which a determination is made of whether the entry 98 being examined is the last entry in the inventory control data structure 64. If it is, the subroutine 129 ends in step 268; otherwise, the execution of loop 250 continues with the system proceeding to the next entry in step 270.

FIG. 16 is a diagram showing data fields within an entry 276 of the product description data structure 30 stored in the web server 10 of FIG. 2. This data structure 30 includes an entry 276 for each different product or item being offered for sale through the web pages. The product description data structure 30, and each of the entries 276 are divided into a entry ID field 278, a special product description data field 280, and a standard product description data field 282. The entry ID field 278 stores an identification word or number associated with the particular product or item being offered for sale. This entry ID has the same value as the entry ID in field 100 of the inventory control structure 64 for the same product. The special product description data field 280 contains all of the information necessary to generate a special web page for the product or item identified by the entry ID field 278 in the entry 276. Similarly, the standard product description data field 282 contains all of the information necessary to generate a standard web page for the product or item identified by the entry ID field 278.

FIG. 17 is a diagram showing data fields within a web pages data structure 32 stored in the web server 10 of FIG. 2. Each of the special web page data fields 284 contains information for advertising a different product or item being offered for sale as a special, while each of the standard web page data fields 286 contains information for offering a different product or item for sale within the standard format of the web pages. The special web page data fields are associated with spaces within the web pages arranged in a predetermined manner, such as the manner shown in FIG. 4 or FIG. 5. Several web page data fields 284, 286 may relate to different spaces on the same web page. In general, both special and standard web page data fields 284, 286 contain data, such as HTML text, causing a standard browser run in a client computer 14 (shown in FIG. 1) to cause the display of information in a predetermined manner. The meanings of a standard browser and of coding causing such a standard browser to display data in a predetermined manner are well understood by those skilled in the art of web page design. The data fields 284, 286 may additionally include data causing images to be displayed, Java applets to provide animation or other functions, and links both to other portions of the web pages being presented and to other web sites.

FIG. 18 is a flow chart of the page update routine 24 executing in the web server of FIG. 2. Referring additionally to FIGS. 7, 14, 16, and 17, this page update routine occurs after the selection data, identifying the entries 98 which have been selected as specials, has been transmitted from the inventory control computer 16 to the web server 10 in step 130 of the subroutine 118. This selection information is transmitted in the form of the entry IDS of the selected entries 98, which have been stored in entry data fields 182, 186, 190, and 194 of the selection data structure 66. After the page update routine 24 is started in step 290, a counter N is set to a value of one in step 292, so that the first entry ID will be read first. Then, a loop 294 is repeated until each of the entry IDS from the selection data structures 66 has been read as the Nth entry in step 296. Then, in step 298, the value of the entry ID read in step 296 is found in the list of entry IDS within field 278 of the product description data structure 30. The entry ID having this value identifies an entry 276 within the product description data structure 30. In step 300, the special product description data from data field 280 of this entry 276 is written to the Nth special web page description data field 284 within the web pages data field 32. After step 300, a determination is made in step 302 of whether all of the entry IDS transmitted from the selection data structure 66 have been evaluated. In the example of the figures, there are four such entry IDS. If all of these entry IDS have been evaluated, the subroutine ends in step 304; otherwise, N is incremented in step 306 before the system returns to step 296 to read the next entry ID.

According to a preferred version of the invention, the special product description data within the data field 280 of the product description data structure 30 includes data which, when loaded into one of the special web page data fields 284 within the web pages data field 32, will cause the browser of a client computer system 14 to display information in a predetermined way. Such data includes, for example, HTML text, data causing images to be displayed, Java applets, and links. With this method, the web page designers have maximum flexibility in determining how each advertisement should appear, whether it is for a special or for a standard offering within the web pages. The operation of the system as described in accordance with the present invention is used merely to determine which products should be offered as specials and to effect the changes necessary to offer them as specials on the web pages. Preferably, these changes are made at a predetermined time, such as a time in the middle of the night, after the sales data for the preceding day has been accumulated.

The method described above does not require the use of the standard product description data within field 282 of the product description data structure 30. While this data is not required for operation in accordance with this version of the present invention, it is included to make the product description data structure more useful in making other types of changes in the web pages.

Alternately, the data in the product description data structure 30 may be structured so that data transferred to the special web page data fields is generated using data from a corresponding entry in the standard product description data field 282, which includes data used in both the standard and special presentations, and data from the special product description data field, which includes data used only in the special presentations. The process of such generation may include changing the format, such a font characteristics, of data from the standard product description data field 282.

The method described above does not cause the standard product description, given in the web pages outside the space in which specials are offered, of an item being offered as a special. It is understood that this is generally a desirable method for maintaining the web pages, since customers may find such items in a familiar manner within the web pages, without even noticing the specials. However, if this method is not desired, data describing the items being offered as specials may be found elsewhere in the web pages, by parsing data within the web pages data structure, and subsequently eliminated.

FIG. 19 is a block diagram of a first alternative system configured to operate according to the invention, with a single web server 310 performing various functions of both the web server 10 (shown in FIG. 2) and the inventory control computer 16 (shown in FIG. 3). Operation of this first alternative system is generally as described above in reference to the first system of FIGS. 1-3, except that the transmission selection step 130 within the process 117 of FIG. 7 is not required, since the selection data structure 312 is held in the data storage 314 of the web server 10 in which the page update instructions 316 are executed. This first alternative system is particularly suited for a small organization, with a single computer performing inventory control and web server functions.

FIG. 20 is a block diagram of a second alternative system configured to operate according to the invention. This second alternative system include a computer system 320 connected to a number of web servers and an inventory control computer 324 over a LAN 326. Operation of this second alternative system is generally as described above in reference to the first system of FIGS. 1-3, except that the inventory control computer 324 must transfer inventory, cost, and price data to the computer system 320 so that the inventory control data structure 326 can be maintained. This data may be transferred on a real time bases, as changes in the values of the data occur, or at a predetermined time before the selection routine instructions are executed within the microprocessor 330. After the web pages stored in a data structure 332 are generated, they are transmitted over the LAN 326 to each of the web servers 322. This second alternative system is particularly suitable for a large organization, in which several web servers 322 are needed to provide the web pages through the Internet 334.

The preceding discussion has assumed an exemplary configuration in which there are four spaces for specials to be advertised. Naturally, the number of specials to be advertised can be as low as a single item or as high as a number much larger than four. In the event that there is a single item, there is generally no concern over categories, unless, for example, only items from a single category are to be considered for advertisement as a special. With a single item to be advertised as a special, the selection data structure 66 of FIG. 14 requires only the first entry field 182 and the first score field 184.

While the invention has been described as facilitating the preparation of web page advertising, it is understood that the invention can also be used to produce other forms of advertising in which certain products are advertised as specials.

While the invention has been described in some degree of particularity, it is understood that this description has been given only as an example, and that numerous changes may be made without departing from the spirit and scope of the invention.

What is claimed is:

1. A computer-implemented method for generating advertising information offering a plurality of products for sale, comprising a plurality of locations for individual advertisements and including at least one special location for prominently advertising a special product, wherein said method comprises:
providing a first data structure including an entry for each product within said plurality of products, wherein said first data structure includes a field identifying each said product and a field including data relating to profit from sales of each said product;
generating a score for each product within said plurality of products from said data relating to profit from sales;
comparing said score for each product within said plurality of products to determine at least one product with promising profit from sales; and
writing at least one code identifying said at least one product with promising profit from sales to a selection data structure.

2. The computer-implemented method of claim 1, additionally comprising:
reading said at least one code from said selection data structure;
reading product advertising information corresponding to said at least one product from a second data structure including an entry for each product within said plurality of products, an identification field including a code identifying each said product and an information field including information describing each said product; and
writing said product advertising information corresponding to said at least one product to a computer readable medium in at least one location corresponding to said at least one special location for prominently advertising a special product.

3. The computer-implemented method of claim 2, wherein
said computer readable medium includes a computer data structure storing data for presentation as one or more web pages, and
said data for presentation as one or more web pages causes a standard browser to display data in a predetermined manner.

4. The computer-implemented method of claim 1, wherein
said field including data relating to profit from sales of each said product includes a field storing data describing profits from an individual sale of each said product and a field storing sales data describing a level of sales of each said product,
said step of providing said first data structure includes updating said sales data, and
said step of generating a score for each product includes multiplying said data relating to profit from sales of each said product by said sales data for each said product to obtain expected profit data.

5. The computer-implemented method of claim 4, wherein
said first data structure additionally includes a field storing an inventory function derived from inventory data for each said product,
said step of providing said first data structure includes updating said inventory function, and
said step of generating a score for each product includes multiplying said expected profit data by said inventory function to lower said score for a product having a low level of inventory.

6. The computer-implemented method of claim 5, wherein
said sales data and said inventory function are updated in a real-time basis as said products are sold,
aid score is generated and said score for each product is compared iteratively at a predetermined time.

7. The computer-implemented method of claim 5, wherein
said sales data and said inventory function are updated and said score is generated in a real-time basis as said products are sold, and
said score for each product is compared iteratively at a predetermined time.

8. A computer-implemented method for generating advertising information offering a first plurality of products for sale, comprising a first plurality of locations for individual advertisements and including a second plurality of special locations for prominently advertising special products, wherein said method comprises:
providing a first data structure including an entry for each product within said first plurality of products, wherein said first data structure includes a field identifying each said product and a field including data relating to profit from sales of each said product;
generating a score for each product within said first plurality of products from said data relating to profit from sales;
comparing said score for each product to determine a second plurality of products with promising profit from sales, wherein a number of products in said second plurality of products is equal to a number of special locations in said second plurality of special locations; and
writing a code identifying each product within said second plurality of products to an identification data field within a selection data structure.

9. The computer-implemented method of claim 8, additionally comprising:
reading said code identifying each product within said second plurality of products from said selection data structure;
reading product advertising information corresponding to each product within said second plurality of products from a second data structure including an entry for each product within said first plurality of products, an identification field storing a code identifying each said product, and an information field storing information describing each said product; and
writing said product advertising information corresponding to each product within said second plurality of products to a computer readable medium in a second plurality of locations corresponding to said second plurality of special locations for individual advertisements.

10. The computer-implemented method of claim 9, wherein
said computer readable medium includes a computer data structure storing data for presentation as one or more web pages, and
said data for presentation as one or more web pages causes a standard browser to display data in a predetermined manner.

11. The computer-implemented method of claim 10, wherein comparing said score for each product causes products having highest levels of scores to be selected as said second plurality of products.

12. The computer-implemented method of claim 11, wherein
said method additionally comprises initializing data stored within a plurality of score data fields within said selection data structure and writing said score for each product within said second plurality of products to a score data field within said selection data structure associated with a data field storing said code identifying said product,
said score for each product is compared to one or more scores stored within said score data field, and
if said score for each product is larger than one or more scores stored within said score data fields, said data fields within said selection data structure are written to include codes identifying products having highest levels of scores and scores of said products having highest levels of scores.

13. The computer-implemented method of claim 10, wherein
said first data structure additionally includes a field identifying a category among a plurality of categories for each product within said plurality of products,
a number of categories in said plurality of categories is equal to said number of special locations in said second plurality of special locations,
said method additionally comprises initializing data stored within a plurality of score data fields within said selection data structure and writing said score for each product within said second plurality of products to a score data field within said selection data structure associated with an identification data field storing said code identifying said product,
each score data field and each identification data field associated with said score data field within said selection data structure stores data from an entry for which a different category is stored in said first data structure,
said score for each product is compared to a score within a score data field associated with a category stored for said product in said first data structure, and
if said score for each product is larger than said score within said score data field associated with said category, said score for each product is written to said score data field associated with said category.

14. A system for communicating web pages having advertising information offering a plurality of products for sale, comprising a plurality of locations for individual advertisements and including at least one special location for prominently advertising a special product, wherein said system comprises:
a server having an interface for communicating over a switched telephone network;
first data storage including a first data structure and a selection data structure, wherein said first data structure stores an entry for each product within a plurality of products, a field storing data identifying each said product, and a field storing data relating to profit from sales of each said product; and
first processor means programmed to read said data identifying each said product and said data relating to profit from sales of each said product, to generate a score for each said product from said data relating to profit from sales of said product, to compare said scores for each said product to determine at least one product with promising profit from sales, and to write at least one code identifying said at least one product with promising profit from sales to said selection data structure.

15. The system of claim 14, additionally comprising:
second data storage including second and third data structures, wherein said second data structure stores an entry for each product within said plurality of products, an identification field storing data identifying each said product, and an information field including information describing each said product and a third data structure, wherein said third data structure stores data for presentation through said server over said switched telephone network, and wherein said third data structure includes at least one special location corresponding to a prominent display of information presented through said server over said switched telephone network; and
second processor means programmed to read said at least one code and data within said identification and information fields, and to write said product advertising information corresponding to said at least one product to said third data structure in at least one location corresponding to said at least one special location within said third data structure.

16. The system of claim 15, wherein
said field including data relating to profit from sales of each said product includes a field storing data describing profits from an individual sale of each said product and a field storing sales data describing a level of sales of each said product,
said system additionally comprises third processor means updating said sales data, and
said first processor means generates a score for each product by a process including multiplying said data relating to profit from sales of each said product by said sales data for each said product to obtain expected profit data.

17. The system claim 16, wherein
said first data structure additionally includes a field storing an inventory function derived from inventory data for each said product,
said third processor means additionally updates said inventory function, and
said first processor means generates a score for each said product by multiplying said expected profit data by said inventory function to lower said score for a product having a low level of inventory.

18. The computer-implemented method of claim 17, wherein
said third processor means updates said sales data and said inventory function in a real-time basis as said products are sold,
said first processor means generates and compares said score iteratively at a predetermined time.

19. The computer-implemented method of claim 17, wherein
said sales data and said inventory function are updated and said score is generated in a real-time basis as said products are sold, and
said first processor means compares said score for each product iteratively at a predetermined time.

20. A system for communicating web pages having advertising information offering a first plurality of products for sale, comprising a first plurality of locations in for individual advertisements and including a second plurality of special locations for prominently advertising special products, wherein said system comprises:
a server having an interface for communicating over a switched telephone network;
first data storage including a first data structure and a selection data structure, wherein said first data structure stores an entry for each product within said first plurality of products, a field storing data identifying each said product, and a field storing data relating to profit from sales of each said product; and
first processor means programmed to read said data identifying each said product and said data relating to profit from sales of each said product, to generate a score for each said product from said data relating to profit from sales of said product, to compare said scores for each said product to determine a second plurality of products with promising profits from sales, wherein a number of products in said second plurality of products is equal to a number of special locations in said second plurality of special locations, and to write a code identifying each product within said second plurality of products to said selection data structure.

21. The system of claim 20, additionally comprising:
second data storage including second and third data structures, wherein said second data structure stores an entry for each product within said plurality of products, an identification field storing data identifying each said product, and an information field including information describing each said product and a third data structure, wherein said third data structure stores data for presentation through said server over said switched telephone network, and wherein said third data structure includes a second plurality of locations corresponding to said second plurality of special locations for prominently advertising special products; and
second processor means programmed to read said code identifying each product within said second plurality of products and data within said identification and information fields, and to write said product advertising information corresponding to said products in said second plurality of products to said third data structure in said second plurality of locations corresponding to said second plurality of special locations for prominently advertising special products.

22. The system of claim 21, wherein comparing said score for each product causes products having highest levels of scores to be selected as said second plurality of products.

23. The computer-implemented method of claim 22, wherein
said first processor means is additionally programmed to initialize data stored within a plurality of score data fields within said selection data structure and to write said score for each product within said second plurality of products to a score data field within said selection data structure associated with a data field storing said code identifying said product,
said score for each product is compared to one or more scores stored within said score data field, and
if said score for each product is larger than one or more scores stored within said score data fields, said data fields within said selection data structure are written to include codes identifying products having highest levels of scores and scores of said products having highest levels of scores.

24. The computer-implemented method of claim 21, wherein
said first data structure additionally includes a field identifying a category among a plurality of categories for each product within said plurality of products,
a number of categories in said plurality of categories is equal to said number of special locations in said second plurality of special locations,
said first processor means is additionally programmed to initialize data stored within a plurality of score data fields within said selection data structure and to write said score for each product within said second plurality of products to a score data field within said selection data structure associated with an identification data field storing said code identifying said product,
each score data field and each identification data field associated with said score data field within said selection data structure stores data from an entry for which a different category is stored in said first data structure,
said score for each product is compared to a score within a score data field associated with a category stored for said product in said first data structure, and if said score for each product is larger than said score within said score data field associated with said category, said score for each product is written to said score data field associated with said category.

25. The system of claim 21, wherein
said system additionally comprises an inventory control computer accessing sales and inventory data,
said first processing means is provided by a microprocessor within said inventory control computer, and
said second processing means is provided by a microprocessor within said server.

26. The system of claim 21, wherein said first and second processing means are provided by a microprocessor within said server.

27. The system of claim 21, wherein
said system additionally comprises an inventory control computer accessing sales and inventory data and a computing system, and
said first and second processing means are provided by a microprocessor within said computing system.

28. A computer readable medium having computer readable code stored thereon for causing a system including at least one computer to perform a method for generating advertising information offering a first plurality of products for sale, comprising a first plurality of locations for individual advertisements and including a second plurality of special locations for prominently advertising special products, wherein said method comprises:
providing a first data structure including an entry for each product within said first plurality of products, wherein said first data structure includes a field identifying each said product and a field including data relating to profit from sales of each said product;
generating a score for each product within said first plurality of products from said data relating to profit from sales;
comparing said score for each product to determine a second plurality of products with promising profit from sales, wherein a number of products in said second plurality of products is equal to a number of special locations in said second plurality of special locations; and
writing a code identifying each product within said second plurality of products to an identification data field within a selection data structure.

29. The computer readable medium of claim 28, wherein said method additionally comprises:
reading said code identifying each product within said second plurality of products from said selection data structure;
reading product advertising information corresponding to each product within said second plurality of products from a second data structure including an entry for each product within said first plurality of products, an identification field storing a code identifying each said product, and an information field storing information describing each said product; and
writing said product advertising information corresponding to each product within said second plurality of products to a computer data structure in a second plurality of locations corresponding to said second plurality of special locations for individual advertisements.

30. The computer readable medium of claim 29, wherein
said computer data structure stores data for presentation as one or more web pages, and
said data for presentation as one or more web pages causes a standard browser to display data in a predetermined manner.

31. The computer readable medium of claim 30, wherein comparing said score for each product causes products having highest levels of scores to be selected as said second plurality of products.

32. The computer readable medium of claim 31, wherein
said method additionally comprises initializing data stored within a plurality of score data fields within said selection data structure and writing said score for each product within said second plurality of products to a score data field within said selection data structure associated with a data field storing said code identifying said product,
said score for each product is compared to one or more scores stored within said score data field, and
if said score for each product is larger than one or more scores stored within said score data fields, said data fields within said selection data structure are written to include codes identifying products having highest levels of scores and scores of said products having highest levels of scores.

33. The computer readable medium of claim 30, wherein
said first data structure additionally includes a field identifying a category among a plurality of categories for each product within said plurality of products,
a number of categories in said plurality of categories is equal to said number of special locations in said second plurality of special locations,
said method additionally comprises initializing data stored within a plurality of score data fields within said selection data structure and writing said score for each product within said second plurality of products to a score data field within said selection data structure associated with an identification data field storing said code identifying said product,
each score data field and each identification data field associated with said score data field within said selection data structure stores data from an entry for which a different category is stored in said first data structure,
said score for each product is compared to a score within a score data field associated with a category stored for said product in said first data structure, and
if said score for each product is larger than said score within said score data field associated with said category, said score for each product is written to said score data field associated with said category.
